(19) United States
(12) Patent Application Publication
(10) Pub. No.: US 2021/0307881 A1
(43) Pub. Date: Oct. 7, 2021

(54) DENTAL IMPLANT HAVING AN UMBRELLA-LIKE ELEMENT

(71) Applicant: UNAC HOLDING AG, Kreuzlingen (CH)

(72) Inventor: Ulrich VOLZ, Kreuzlingen (CH)

(73) Assignee: UNAC HOLDING AG, Kreuzlingen (CH)

(21) Appl. No.: 16/474,651

(22) PCT Filed: Dec. 29, 2017
(86) PCT No.: PCT/IB2017/058506

§ 371 Date: Jul. 15, 2019

(30) Foreign Application Priority Data
Dec. 29, 2016 (DE) 102016125828.8

(51) Int. Cl. A61C 8/00

(52) U.S. Cl. CPC A61C 8/0092; A61C 8/0033; A61C 8/0022

(57) ABSTRACT

A dental implant for screwing into a bone includes a main body and at least one thread formed with the main body. At least one umbrella-like element is provided on the dental implant, the diameter of the umbrella-like element being less than or equal to the largest diameter of the dental implant.

### TECHNICAL FIELD

The invention relates to a dental implant to be screwed into a bone, consisting of a basic body as well as at least one thread formed with the basic body.

### STATE OF THE ART

Sinus lift refers to a special operation method of maxillofacial surgery, with which the osseous bottom of the maxillary sinus (Sinus maxillaris) is thickened. Sinus lift is one of multiple methods for building up the jaw. The reason for use of the method is that a thin bone layer is not thick enough to accommodate a cylindrically shaped implant body with excess bone all around. A predominant part of this implant cylinder would come to stand in the maxillary sinus, while the thin bone layer is not able to impart the required hold to the implant. The sinus lift operation has the goal of thickening the bone layer of the sinus bottom, wherein the inner side of the maxillary sinus mucous membrane is lifted (English: lifting) in the manner described below.

In the previously known techniques, first the mucous membrane of the maxillary sinus, called the “Schneiderian membrane,” is carefully released from the maxilla bone. The “Schneiderian membrane” separates the maxillary sinus from the maxilla. When this membrane is released from the maxilla, a cavity is created between this membrane, i.e. this mucous membrane and the maxilla, into which cavity suitable bone replacement material can now be filled. Then—over time—“additional bone” can then form from this material, which has been introduced from the outside.

Thus, a corresponding apparatus is also known in the state of the art (EP 0 748 616 B1), with which the mucous membrane can be lifted using a hat-like element. This apparatus consists essentially of three parts, namely first of all a sleeve-shaped element that is inserted into the maxilla, in particular screwed in, wherein a type of screw is then passed through the center of the sleeve-shaped element. A hat-shaped element can, in turn, be screwed onto an end of the corresponding screw, using which element the mucous membrane can be lifted.

In another method, a specially developed technique is involved, so as to release the maxillary sinus mucous membrane from the osseous bottom of the maxillary sinus by means of a liquid-filled balloon catheter, in minimally invasive manner (i.e. with the least possible damage to soft tissue). In this regard, similar to an indirect sinus lift, the operation takes place in transcrestal manner (through the alveolar ridge). Using a controllable drilling system, drilling takes place to approximately 1 mm from the bottom of the maxillary sinus. Afterward, the remaining bone (approximately 1 mm) is pushed forward in the direction of the maxillary sinus by means of a special osteotome. During this process, the maxillary sinus mucous membrane remains undamaged. Release of this mucous membrane from the bottom of the maxillary sinus then takes place using a liquid-filled balloon catheter. The volume and the release height of the mucous membrane can be precisely determined by means of controllable filling of the balloon. This newly created space is filled with bone reconstruction material by way of the access through the alveolar crest, similar to an indirect sinus lift.

Autogenic bone (from the patient's own body) and/or bone replacement materials (BRM) are introduced into the operatively created cavity (embedding osteoplasty).

### DISADVANTAGES OF THE STATE OF THE ART

Although the sinus lift method is a very common and known method, nevertheless complications such as infections or dehiscences, going as far as total loss, occur again and again within the scope of its use. Unfortunately, no “Restitutio ad Integrum” can be expected in these cases, and both the sinus mucous membrane and the oral soft tissue are often permanently compromised.

### TASK OF THE INVENTION

The task of the invention consists in creating an implant that is suitable for a sinus lift treatment and prevents the mucous membrane of the maxillary sinus from being cut or torn.

### SOLUTION OF THE TASK

The solution of the task consists in providing a disk-shaped formation at the free end of the implant, for example, which is larger, with reference to the diameter, than the diameter of the implant.

### ADVANTAGES OF THE INVENTION

By means of the method, which is carried out using a specially configured dental implant, on the one hand a minimally invasive and atraumatic operation technique is provided, during which the treatment takes place exclusively with natural, autologous and thereby the body's own substances. On the other hand, only biologically highly compatible implant materials are introduced. When using ceramic dental implants, metal-free treatment is carried out.

These dental implants have an umbrella-like element at their apical end, which element is as large as possible, so as to support the Schneiderian membrane over a large area and therefore with minimized risk with regard to perforations. At the same time, a large peri-implant cavity is supposed to be created and kept open over the required period of time, as a result of which a bioactive container is produced. In this container, purely autologous bone regeneration is to take place, initiated by way of the blood clot, which regeneration is supposed to lead to a Haversian bone morphology in the long term. An improvement in the extracellular matrix is achieved, namely by means of creation of a stable cavity, formed by the osseous maxillary cavity bottom and the Schneiderian membrane. It was shown that new bone is regularly formed in contact with the Schneiderian membrane, even in pure blood clot regions, and this documents the osteo-inductive property of the maxillary sinus membrane. Avoidance of secondary materials for bone replacement increases the proportion and the expanse of a blood-vessel-rich Haversian bone morphology, which arises by way of initial blood vessel formation in an autologous blood clot with subsequent growth of fibrous bone, from which a lamellar bone structure forms.

Due to the umbrella-like formation, the Schneiderian membrane is prevented from being injured by the dental implant. This is because comparable to a finger that presses into an inflated balloon, the umbrella-like element presses the mucous membrane back into the maxillary sinus, so that the cavity is maintained and the mucous membrane is not injured by the pointed formation of the implant.

The umbrella-like element has a diameter that is equal to or smaller than the largest diameter of the dental implant. As a result, introduction of the dental implant into the pre-drilled maxillary bone is possible.

A simple embodiment provides that the umbrella-like element is disposed at the apical end of the dental implant, and has a disk-shaped configuration. Preferably, the outer edge of the disk-shaped configuration has a large radius, so as to thereby reduce the perforation risk of the Schneiderian membrane. The disk-like configuration is advantageously configured in one piece with the dental implant and disposed in such a manner that the center point of the disk-like configuration is congruent with the longitudinal axis of the dental implant. Since the dental implant consists of a ceramic material, for example zirconium oxide, the disk-like configuration can be produced from the identical material, independent of whether it is configured in one piece or consists of two parts and the disk-like configuration is attached to the dental implant.

A further embodiment of the umbrella-like element consists in that it has a concave structure. The half-shell configuration is disposed, in the assembled state, in such a manner that the membrane is carried by the concave side of the umbrella-like element. The advantage of this embodiment lies in that the forces that act on the membrane are distributed and are designed to be less point by point, so that perforation can be prevented for the most part.

Another embodiment provides that the umbrella-like element is disposed on the dental implant in movable manner. As a result, it is possible that the umbrella-like element automatically adapts to the tension conditions of the Schneiderian membrane, so that here, too, corresponding perforation can be prevented. In this regard, the movable arrangement can be provided both for a disk-like element and for an umbrella-like element.

A further embodiment provides that the umbrella-like element element is in fact configured like an umbrella, wherein the umbrella is unfolded only in the installed state. Corresponding mechanisms, which are present in the dental implant, bring with them the possibility that the umbrella-like element can be unfolded or folded up. The umbrella-like element consists of a fabric-like material, which is flexible but nevertheless rigid, so as to carry the Schneiderian membrane and hold it at a distance. Corresponding support mechanisms, as they are also present in an umbrella, are implemented here, as well.

The umbrella-like element is either equal to or smaller, in terms of its diameter, than the diameter of the dental implant. The reason for this lies in the fact that the dental implant, the umbrella-like element of which is an integrative component of the dental implant, must be introduced into the maxilla through a bore. The diameter of the bore approximately corresponds to the diameter of the dental implant, preferably the greater diameter of the dental implant, so that a disk-like configuration of the umbrella-like element, in particular, introduction is just possible then.

A further development provides that the disk-like configuration is disposed not at the free end, namely the apical end of the implant, but rather on the basic body of the implant. As a result, formation of a cavity can also be created, so as to make it possible that bleeding into the cavity takes place to produce bone growth.

### DRAWINGS

FIG. 1 a schematic view of the upper jaw and lower jaw, with the maxillary sinus and two inserted dental implants;

FIG. 2 a perspective schematic view of a first exemplary embodiment of the dental implant according to the invention;

FIG. 3 a further perspective schematic view of a second exemplary embodiment of the dental implant according to the invention.

### DESCRIPTION OF AN EXEMPLARY EMBODIMENT

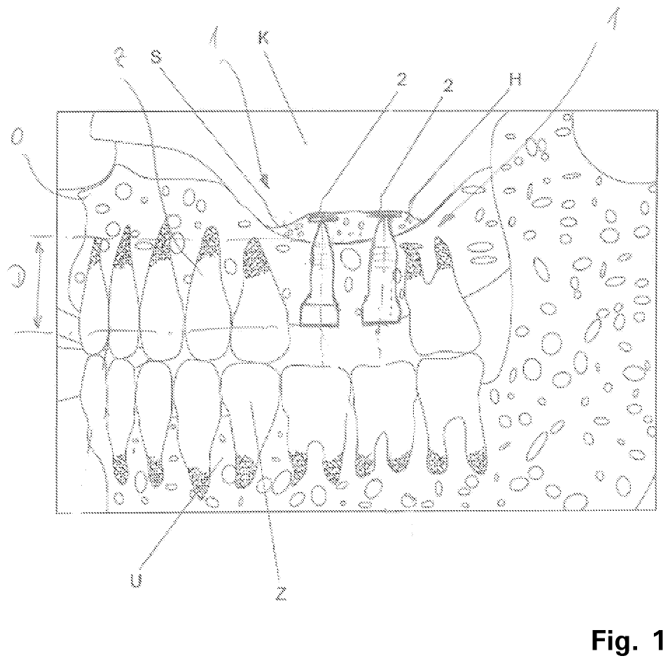

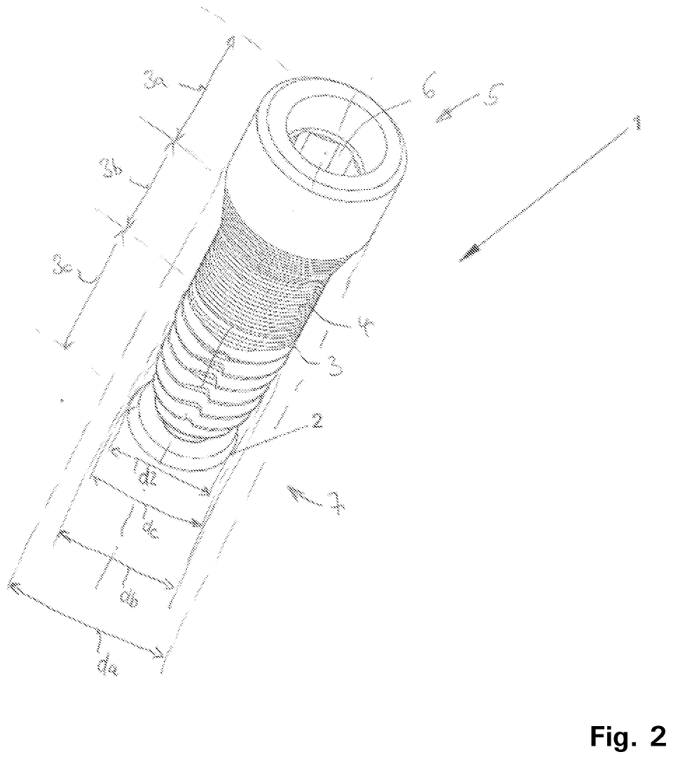

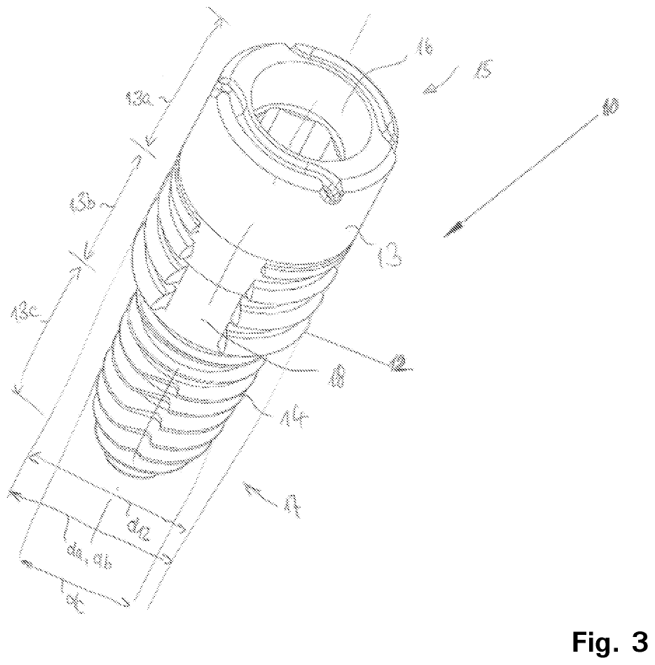

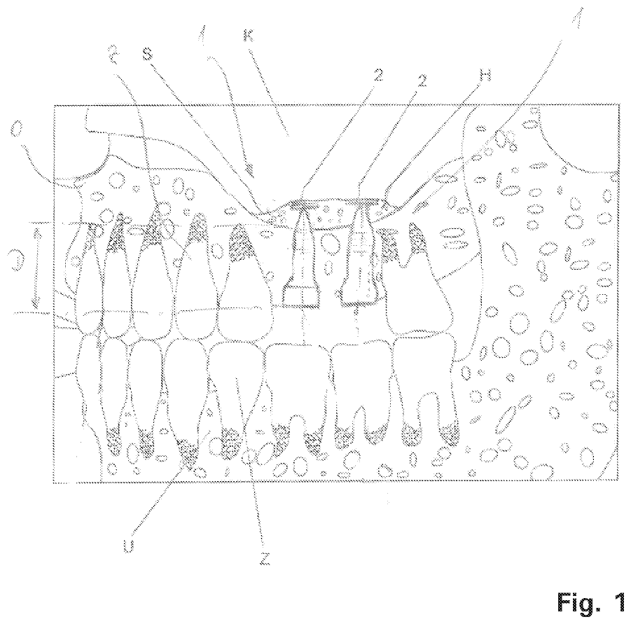

In FIG. 1, a schematic view of the upper jaw O and the lower jaw U of a human being is shown. Teeth Z are disposed in the upper jaw O and the lower jaw U.

At one location in the upper jaw O, the thickness D of the bone of the upper jaw O is dimensioned to be very slight, so that the dental implants 1 to be introduced do not find sufficient hold. For this reason, it is necessary to remove the Schneiderian membrane S from the bone K on the side of the maxillary cavity K, where it is disposed, and to form a cavity H. In this cavity H, until now bone material M has been introduced, so as to make available the required thickness for holding the dental implants 1.

The invention takes a different path. By means of screwing in the dental implants 1, which have an umbrella-like configuration 2 at their free end in the exemplary embodiment shown in the figures, the Schneiderian membrane S is forced back into the maxillary sinus K, so that a cavity H is formed, in which bone grown is promoted by means of bleeding into the cavity, and autologous bone is formed. For this purpose, the upper jaw O is pre-drilled, so that the dental implant 1 with the umbrella-like element 2 connected with it in one piece can be introduced into the bore that has been made available.

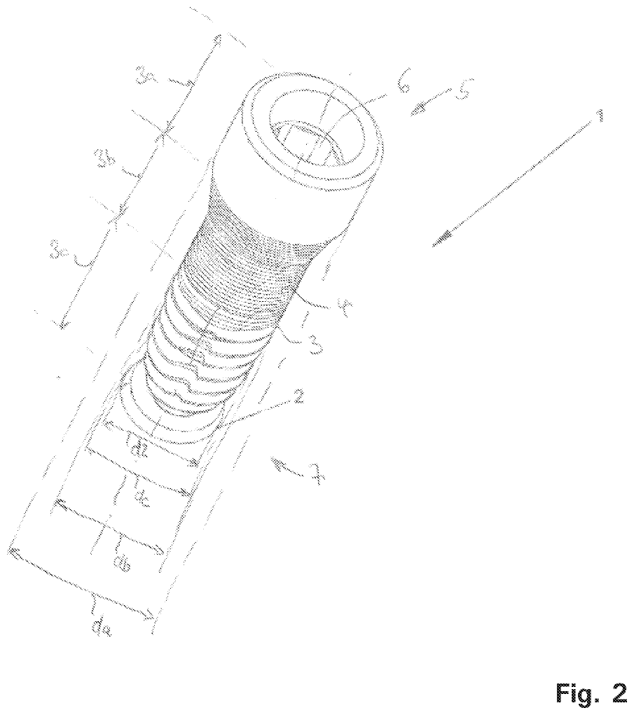

In FIG. 2, a first exemplary embodiment of the structure of a dental implant 1 according to the invention is shown. It comprises a basic body 3, the outside circumference of which is provided with at least one thread 4. A holder 6 for a screw-in apparatus (not shown in the drawings) is provided axially at the distal end 5. The embodiment shown in FIG. 2 has a basic body 3, which a first region 3a with a diameter da, a second region 3b with a diameter db, and a third region 3cm, the diameter of which decreases in an apical direction from a diameter dc, wherein da>db>dc.

On its apical side 7 of the dental implant 3, an umbrella-like element 2 is provided. This umbrella-like element 2 is a disk-like element having a slight thickness (for example 0.5 mm) in the case of the embodiment shown here, so that the mucous membrane (Schneiderian membrane) is forced back into the maxillary sinus K in umbrella-like manner, and is also held there accordingly, without damage. This umbrella-like element 2 has a diameter d2. This diameter d2 is less, in terms of its size, than the greatest diameter of the dental implant 1; in the case of the exemplary embodiment shown here, the greatest diameter is da.

It is conceivable that this disk-like configuration can be provided on any type of implant for the dental sector, if a sinus lift treatment is being carried out. In this regard, it is not necessary that the dental implants have three regions, as described above.

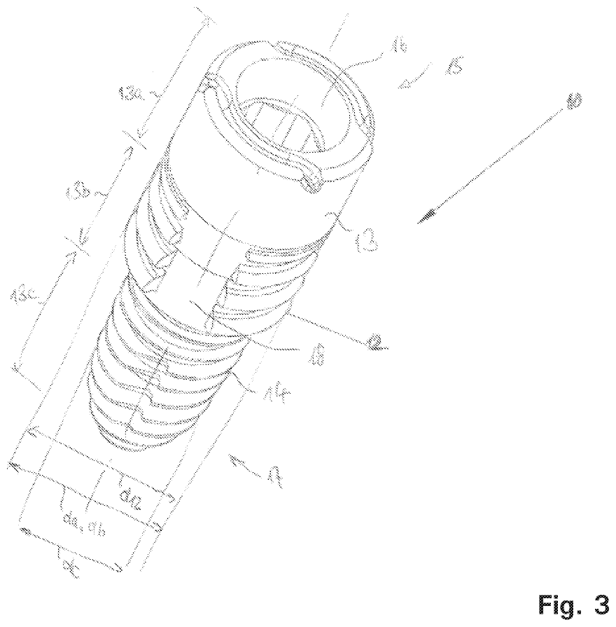

In FIG. 3, a further embodiment of a dental implant 10 is shown. It comprises a basic body 13, the outside circumference of which is provided with at least one thread 14. Axially, a holder 16 for a screw-in device (not shown in the drawings) is provided axially at the distal end 15. The embodiment shown in FIG. 3 shows a basic body 13, which a first region 13a with a diameter da, a second region 13b with a diameter db, and a third region 13c, the diameter of which decreases in an apical direction from a diameter dc, wherein da>db>dc. The further exemplary embodiment in FIG. 3 differs from the one in FIG. 2 in that an umbrella-like element 12 in a disk-like configuration is present not at the apical end 17, but rather in the region 13a-13c of the basic body 13 of the dental implant 1, once or multiple times (here in the region 13b). The disk-like configuration disposed on the basic body is interrupted in at least one location 18, so as to allow it to be screwed into the bone. By means of this configuration, cavities are also formed, in which autologous bone material can be obtained accordingly, by means of bleeding into the cavity.

### REFERENCE SYMBOL LIST

Dental Implant with an Umbrella-Like Element
1 dental implant
2 umbrella-like element
3 basic body
3a-3c regions
4 thread
5 distal end
6 holder
7 apical end
8 -
9 -
10 dental implant
11 -
12 umbrella-like element
13 basic body
13a-13c regions
14 thread
15 distal end
16 holder
17 apical end
18 location
D thick maxilla
H cavity
K maxillary sinus
M bone material
upper jaw
S Schneiderian membrane
U lower jaw

1: A dental implant to be screwed into a bone, comprising a basic body as well as at least one thread formed with the basic body, wherein at least one umbrella-like element (2; 12) is provided on the dental implant (1; 10), which element, with reference to its diameter (d2; d12), is equal to or smaller than the largest diameter (da, db, dc) of the dental implant (1; 10).

2: The dental implant according to claim 1, wherein the umbrella-like element (2; 12) has a disk-like or partial-disk-like configuration.

3: The dental implant according to claim 1, wherein the umbrella-like element (2; 12) is rigid.

4: The dental implant according to that claim 1, wherein the umbrella-like element (2; 12) is configured in one piece with the dental implant (1; 10).

5: The dental implant according to claim 1, wherein the umbrella-like element (2; 12) has a disk-like configuration with a diameter (d2; d12), wherein the center point of the disk-like configuration is congruent with the longitudinal axis of the dental implant (1; 10).

6: The dental implant according to claim 1, wherein the umbrella-like element (2; 12) can be converted from a folded-up position into an unfolded position.
